(19) United States
(12) Patent Application Publication
(10) Pub. No.: US 2024/0240929 A1
(43) Pub. Date: Jul. 18, 2024

(54) DETECTION DEVICE

(71) Applicant: DENSO CORPORATION, Kariya-city (JP)

(72) Inventors: NAO UEMATSU, Kariya-city (JP); TOSHIHIRO FUJITA, Kariya-city (JP)

(21) Appl. No.: 18/620,680

(22) Filed: Mar. 28, 2024

Related U.S. Application Data
(63) Continuation of application No. PCT/JP2022/034753, filed on Sep. 16, 2022.

(30) Foreign Application Priority Data
Sep. 30, 2021 (JP) 2021-161473

(51) Int. Cl. G01B 7/30

(52) U.S. Cl. CPC G01B 7/30

(57) ABSTRACT

A detection device includes a sensor and a control unit. The sensor includes at least one main detection element configured to detect a change in a physical quantity of a detection target, at least one sub detection element configured to detect a change in a physical quantity of the detection target, and a signal processing section configured to process a detection signal of the main detection element. The control unit acquires a signal from the sensor according to a change in the physical quantity of the detection target. The sensor outputs to the control unit a digital signal containing information corresponds to a detection value of the main detection element and an analog signal that corresponds to a detection value of the sub detection element.

### CROSS REFERENCE TO RELATED APPLICATIONS

This application is a continuation application of International Patent Application No. PCT/JP2022/034753 filed on Sep. 16, 2022, which designated the U.S. and based on and claims the benefits of priority of Japanese Patent Application No. 2021-161473 filed on Sep. 30, 2021. The entire disclosure of all of the above applications is incorporated herein by reference.

### TECHNICAL FIELD

The present disclosure relates to a detection device.

### BACKGROUND

Conventionally, a rotation detection device that detects a rotation of a motor is known.

### SUMMARY

An object of the present disclosure is to provide a detection device that can simplify a configuration of a sensor.

A detection device of the present disclosure includes a sensor and a control unit. The sensor includes at least one main detection element configured to detect a change in a physical quantity of a detection target, at least one sub detection element configured to detect a change in a physical quantity of the detection target, and a signal processing section configured to process a detection signal of the main detection element. The control unit acquires a signal corresponding to a change in the physical quantity of the detection target from the sensor.

The sensor outputs to the control unit a digital signal containing information generated by the signal processing section corresponding to the detection value of the main detection element and an analog signal corresponding to the detection value of the sub detection element.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic configuration view of a steering system according to a first embodiment;

FIG. 2 is a cross sectional view of a drive device according to the first embodiment;

FIG. 3 is a block view showing a rotation detection device according to the first embodiment;

FIG. 4 is a plan view showing a rotation angle sensor according to the first embodiment with a sealing part removed;

FIG. 5 is a plan view showing a chip arrangement of the rotation angle sensor according to the first embodiment;

FIG. 6 is a view seen from a direction of an arrow VI in FIG. 5;

FIG. 7 is a block view showing a rotation detection device according to a second embodiment;

FIG. 8 is a plan view showing a chip arrangement of a rotation angle sensor according to the second embodiment;

FIG. 9 is a plan view showing a chip arrangement of a rotation angle sensor according to a third embodiment;

FIG. 10 is a view seen from a direction of an arrow X in FIG. 9;

FIG. 11 is a plan view showing a chip arrangement of a rotation angle sensor according to a fourth embodiment;

FIG. 12 is a view taken in a direction of an arrow XII in FIG. 11;

FIG. 13 is a plan view showing a chip arrangement of a rotation angle sensor according to a fourth embodiment;

FIG. 14 is a plan view showing a chip arrangement of a rotation angle sensor according to a fifth embodiment;

FIG. 15 is a view taken in a direction of an arrow XV direction of FIG. 14;

FIG. 16 is a plan view showing a chip arrangement of a rotation angle sensor according to a fifth embodiment;

FIG. 17 is a block view showing a rotation detection device according to a sixth embodiment;

FIG. 18 is a side view of a rotation angle sensor according to the sixth embodiment;

FIG. 19 is a side view of a rotation angle sensor according to the sixth embodiment;

FIG. 20 is a block view showing a rotation detection device according to a seventh embodiment;

FIG. 21 is a side view of a rotation angle sensor according to the seventh embodiment;

FIG. 22 is a block view showing a rotation detection device according to an eighth embodiment;

FIG. 23 is a block view showing a rotation detection device according to a ninth embodiment;

FIG. 24 is a block view showing a rotation detection device according to a tenth embodiment;

FIG. 25 is a time chart illustrating signal acquisition timing according to the tenth embodiment;

FIG. 26 is a time chart illustrating signal acquisition timing according to an eleventh embodiment;

FIG. 27 is a block view showing a rotation detection device according to a twelfth embodiment;

FIG. 28 is a block view showing a rotation detection device according to a thirteenth embodiment; and

FIG. 29 is a time chart illustrating signal acquisition timing according to a reference example.

### DETAILED DESCRIPTION

In an assumable example, a rotation detection device that detects a rotation of a motor is known. For example, the rotation detection device includes a plurality of sensor units.

In the example, a rotation angle calculation section and a digital communication section are provided for each sensor element, and a first sensor unit and a second sensor unit have the same configuration. However, the plurality of sensor units may not necessarily have the same configuration. An object of the present disclosure is to provide a detection device that can simplify a configuration of a sensor.

A detection device of the present disclosure includes a sensor and a control unit. The sensor includes at least one main detection element configured to detect a change in a physical quantity of a detection target, at least one sub detection element configured to detect a change in a physical quantity of the detection target, and a signal processing section configured to process a detection signal of the main detection element. The control unit acquires a signal corresponding to a change in the physical quantity of the detection target from the sensor.

The sensor outputs to the control unit a digital signal containing information generated by the signal processing section corresponding to the detection value of the main detection element and an analog signal corresponding to the detection value of the sub detection element. Therefore, the configuration of the sensor can be simplified.

Hereinafter, a detection device according to the present disclosure will be described based on the drawings. In the following plural embodiments, substantially same structural configurations are designated with the same reference numerals thereby to simplify the description.

### First Embodiment

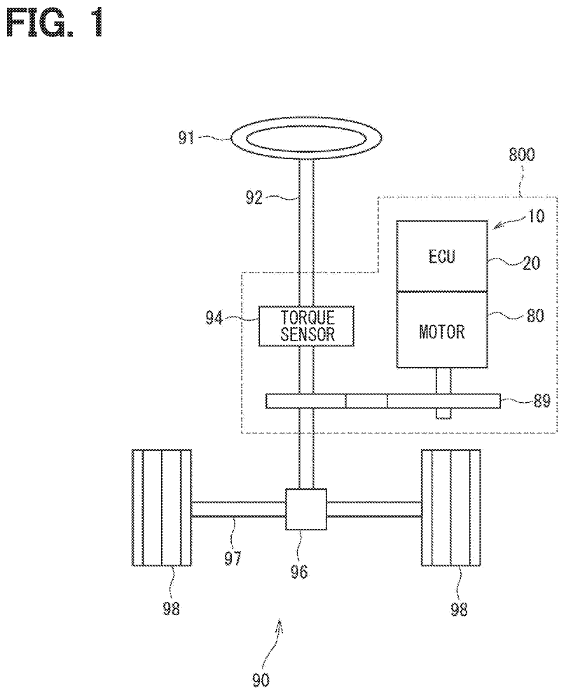

A first embodiment is shown in FIGS. 1 to 6. As shown in FIGS. 1 to 3, a rotation detection device 1 as a detection device includes a rotation angle sensor 31 and a control unit 60, and is applied to an electric power steering device 800. FIG. 1 shows the configuration of a steering system 90 including the electric power steering device 800. The steering system 90 includes a steering wheel 91, a steering shaft 92, a pinion gear 96, a rack shaft 97, road wheels 98, the electric power steering device 800 and the like.

The steering wheel 91 is connected to the steering shaft 92. A torque sensor 94 is provided on the steering shaft 92 to detect a steering torque. The pinion gear 96 is provided at an axial end of the steering shaft 92. The pinion gear 96 meshes with the rack shaft 97. A pair of road wheels 98 is coupled at both ends of the rack shaft 97 via, for example, tie rods.

When a driver of the vehicle rotates the steering wheel 91, the steering shaft 92 connected to the steering wheel 91 rotates. A rotational movement of the steering shaft 92 is converted into a linear movement of the rack shaft 97 by the pinion gear 96. The pair of road wheels 98 is steered to an angle corresponding to the displacement amount of the rack shaft 97.

The electric power steering device 800 includes a drive device 10 having an ECU 20 and a motor 80, a reduction gear 89 that is a power transmission unit that reduces rotation of the motor 80, and transmits the reduced rotation to the steering shaft 92. That is, the electric power steering device 800 of the present embodiment is a column assist type, in which the steering shaft 92 is an object to be driven. The electric power steering device 800 may be a rack assist type, in which the rotation of the motor 80 is transmitted to the rack shaft 97.

The motor 80 outputs part or all of a torque required for steering, and is driven by a power supplied from a battery (not shown) to rotate the reduction gear 89 forward and backward. The drive device 10 is a so-called “mechanically and electrically integrated type” in which the ECU 20 is provided on one side in an axial direction of the motor 80, but it may be a mechanical and electrically separated type in which the motor and the ECU are separately provided. By adopting a mechanical and electrical integrated type, the ECU 20 and the motor 80 can be efficiently arranged in a vehicle having a limited mounting space. The ECU 20 is positioned coaxially with an axis of a shaft 870 on a side opposite to the output shaft of the motor 80.

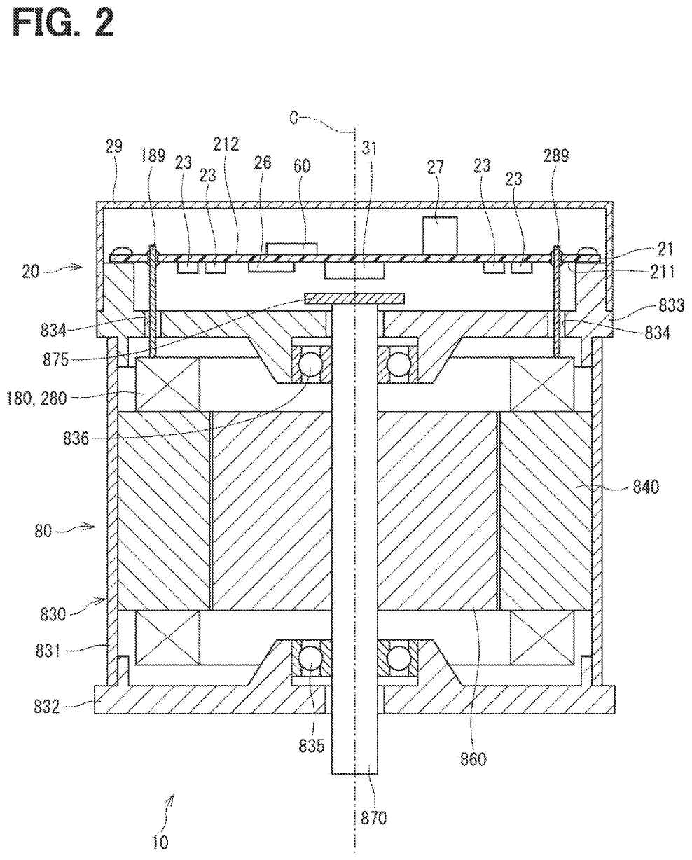

As shown in FIG. 2, the motor 80 is a three-phase brushless motor which includes motor windings 180, 280, a stator 840, a rotor 860, a housing 830 that houses them, and the like. The housing 830 has a cylindrical case 831, a front end frame 832 and a rear end frame 833. The case 831 and the end frames 832 and 833 are fastened to each other by bolts or the like.

The stator 840 is fixed to the case 831 and the motor windings 180 and 280 are wound on the stator 840. Lead wires 189 and 289 are taken out from the motor windings 180 and 280, respectively. The lead wires 189 and 289 are taken out to the ECU 20 side from an insertion hole 834 formed in the rear end frame 833 and connected to a board 21. The rotor 860 is provided radially inside the stator 840 to be rotatable relative to the stator 840.

The shaft 870 is fitted firmly in the rotor 860 to rotate integrally with the rotor 860. The shaft 870 is rotatably supported by the housing 830 through bearings 835 and 836. An end portion of the shaft 870 on the ECU 20 side projects from the rear end frame 833 toward the ECU 20 side. A magnet 875 is placed at the end of the shaft 870 on the ECU 20 side. Hereinafter, the axis passing through the center of the magnet 875 will be referred to as a center line C.

The ECU 20 includes the board 21, a cover 29, and the like. The cover 29 is fixed to the rear end frame 833 and protects electronic components from external impacts and prevents dust and water from entering the ECU 20. A connector (not shown) is provided on the cover 29.

The board 21 is, for example, a printed circuit board, and is fixed to the rear end frame 833. On the board 21, a switching element 23, a custom IC 26, a capacitor 27, the rotation angle sensor 31, a microcomputer forming the control unit 60, and the like are mounted. In FIG. 2, reference numeral 60 is assigned to the computers provided as the control unit 60.

In the present embodiment, the switching element 23, the custom IC 26, the rotation angle sensor 31, etc. are mounted on a motor surface 211, which is the surface on the motor 80 side of the board 21, and a capacitor 27, a microcomputer, etc. are mounted on a cover surface 212, which is a surface of the board 21 opposite to the motor 80. According to the present embodiment, the electronic components are mounted on one board 21. The electronic components may alternatively be mounted on plural boards.

The switching elements 23 constitute an inverter that switches energization of the motor windings 180 and 280. The switching elements 23 are provided at the rear end frame 833 so as to be able to radiate heat, but a heat sink may be provided separately from the rear end frame 833 to radiate heat. The custom IC 26 includes a pre-driver, an amplifier circuit, and the like.

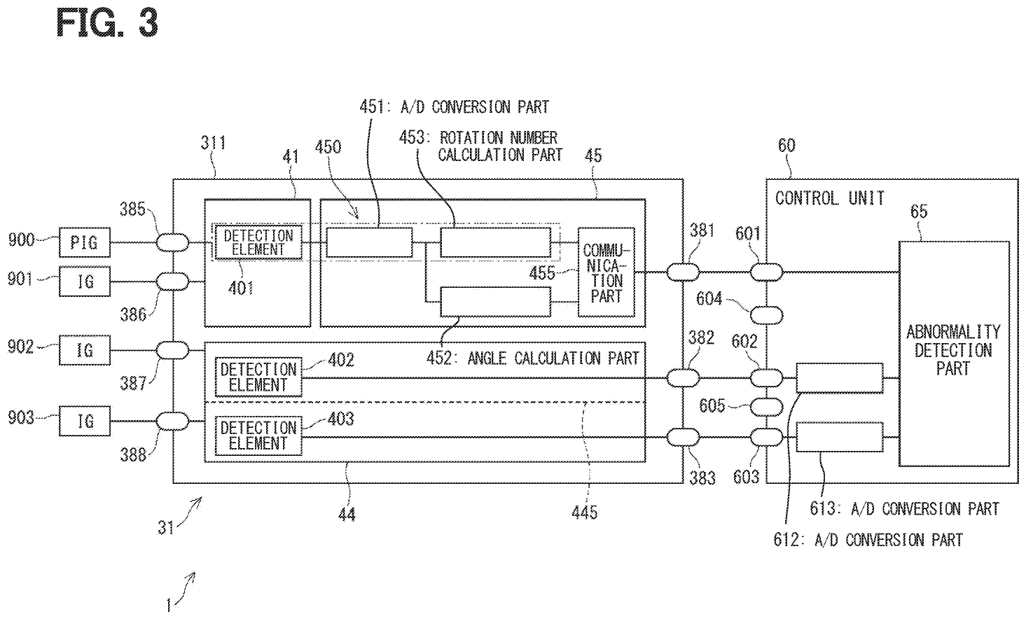

As shown in FIG. 3, the rotation angle sensor 31 includes chips 41, 44, a signal processing chip 45, and a sealing part 311 that seals these chips. The main chip 41 has a detection element 401. The sub chip 44 has detection elements 402 and 403. The detection elements 402 and 403 are separated by an insulating part 445 within the same chip.

The detection elements 401 to 403 are, for example, a magnetic resistance element such as AMR sensor, TMR sensor, and GMR sensor, and a Hall element, etc., and detect the magnetic field of the magnet 875 that changes with the rotation of the motor 80, and output a set of sine and cosine signals that are analog signals. The detection elements 401 to 403 may be the same or may have different amplitudes, etc. Alternatively, the detection element 401 may have a higher detection accuracy than the detection elements 402 and 403, for example. When different types of elements are used for at least some of the detection elements 401 to 403, the failure modes are different, so the probability of simultaneous failure can be reduced.

In the present embodiment, a detection value of the main detection element 401 is used for control, and the detection values of the sub detection elements 402 and 403 are used for abnormality detection. The detection values of the detection elements 402 and 403 may be used for backup control when the main detection element 401 is abnormal. Hereinafter, the configuration corresponding to the detection elements 401 to 403 will be referred to as a “system”, the system related to the detection element 401 will be referred to as a main system, and the system corresponding to the detection elements 402 and 403 will be referred to as a sub system.

The signal processing chip 45 constitutes a signal processing section 450 and is connected to the main chip 41. The signal processing section 450 includes an AD conversion part 451, an angle calculation part 452, a rotation number calculation part 453, and a communication part 455. The AD conversion part 451 converts the sine signal and the cosine signal output from the main detection element 401 into digital signals.

The angle calculation part 452 calculates a motor rotation angle θ, which is a rotation angle of the rotor 860, using the sine signal and the cosine signal digitally converted by the AD conversion part 451. The rotation number calculation part 453 calculates the rotation number TC of the motor 80 using the sine signal and the cosine signal digitally converted by the AD conversion part 451. The communication part 455 transmits a digital signal including information regarding the motor rotation angle θ and the rotation number TC to the control unit 60. The motor rotation angle θ and the rotation number TC are used by the control unit 60 for various control calculations.

The sealing part 311 is provided with output terminals 381 to 383 and power supply terminals 385 to 388. The output terminal 381 is connected to a terminal 601 of the control unit 60 and is used to output a digital signal including a value calculated using the detection value of the main detection element 401.

The output terminal 382 is connected to a terminal 602 of the control unit 60 and is used to output an analog signal according to the detection value of the sub detection element 402. The output terminal 383 is connected to a terminal 603 of the control unit 60 and is used to output an analog signal according to the detection value of the sub detection element 403.

In FIG. 3, each output terminal 381 to 383 and each communication line are provided one for each system, but a plurality of output terminals 381 to 383 and communication lines may be provided for at least some systems depending on the communication system and data system. Further, an amplifier circuit or a filter circuit may be provided.

At least one NC (Non Connection) terminal 604 is provided between the terminals 601 and 602, and at least one NC terminal 605 is provided between the terminals 602 and 603. Here, when the terminals 601 to 603 are arranged adjacent to each other, and when a short circuit occurs between the adjacent terminals due to a foreign object or the like, there is a possibility that a plurality of detection signals may become abnormal due to a common cause failure. In the present embodiment, since the NC terminal 604 is provided between the terminals 601 and 602 and the NC terminal 605 is provided between the terminals 602 to 603, it is possible to prevent a plurality of detection signals from becoming abnormal due to a common cause failure.

The power supply terminal 385 is connected to PIG power supply 900, which is directly connected to the battery. The power supply terminals 386 to 388 are connected to the IG power supplies 901 to 903, which are connected to a battery via a vehicle starting switch (hereinafter referred to as “IG”). Although the IG power supplies 901 to 903 are shown separately in FIG. 3, at least some of them may be a common power supply. Further, the power supply terminals 385 to 388 may be supplied with stepped-up and stepped-down power from the respective power supplies 900 to 903.

The power supply terminals 385 and 386 are connected to the main chip 41 and the signal processing chip 45, and the detection element 401, the AD conversion part 451, and the number of rotation number calculation part 453, which are surrounded by one-dot chain lines, are constantly supplied with power via the power supply terminal 385 even when the IG is off. The power supply terminal 387 is connected to the sub detection element 402 of the sub chip 44, and the power supply terminal 388 is connected to the sub detection element 403 of the sub chip 44. That is, in the present embodiment, the power supply terminals 385 to 388 are individually provided for each of the detection elements 401 to 403, so that the power supplies are configured so that they do not interfere with each other within the package. package. Furthermore, the detection elements 401 to 403 are configured to ensure insulation between the elements.

The control unit 60 is mainly composed of a microcomputer and the like, and internally includes, although not shown in the figure, a CPU, a ROM, a RAM, an I/O, a bus line for connecting these components, and the like. Each process executed by the control circuit unit 60 maybe a software process or may be a hardware process. The software process may be implemented by causing the CPU to execute a program. The program may be stored beforehand in a memory device such as a ROM, that is, in a computer-readable, non-transitory, tangible storage medium. The hardware process may be implemented by a special purpose electronic circuit.

The control unit 60 includes AD conversion parts 612 and 613, an abnormality detection part 65, and the like. The AD conversion part 612 converts the analog signal output from the sub detection element 402 into a digital signal. The AD conversion part 613 converts the analog signal output from the sub detection element 403 into a digital signal.

The AD conversion parts 612 and 613 are provided on the control unit 60 side. That is, the detection values of the sub detection elements 402 and 403 are not digitally converted and are output to the control unit 60 as analog signals. In other words, in the rotation angle sensor 31, the configuration related to signal processing of the sub detection elements 402 and 403 is omitted, and the configuration of the rotation angle sensor 31 is simplified.

The abnormality detection part 65 performs an abnormality detection by comparing the detection values of the detection elements 401 to 403. In the present embodiment, by using three signals output corresponding to each of the detection elements 401 to 403, an abnormal system can be identified by a majority vote of the three output signals, and control and abnormality monitoring based on the detected values of the normal system can be continued. Details of abnormality detection will be described later in an eighth embodiment and thereafter.

Here, the calculation of a steering angle θs will be explained. The control unit 60 calculates the steering angle θs by using a motor rotation angle θ, the rotation number TC, and the gear ratio of the reduction gear 89. The steering angle may be calculated on the rotation angle sensor 31 side. The number of rotations TC can be calculated based on the count value, for example, by dividing one rotation of the motor 80 into three or more regions and counting up or down according to the rotation direction each time the region changes. In the present embodiment, power is constantly supplied to the detection element 401, the AD conversion part 451, and the rotation number calculation part 453 so that calculation of the number of rotations TC is continued even during the period when the IG is turned off.

Thereby, even if the motor 80 is rotated by steering the steering wheel 91 while the IG is turned off, the steering angle θs can be calculated without relearning a reference position. Since the value when the IG is on may be used as the motor rotation angle θ, there is no need to continue calculation by constant power supply.

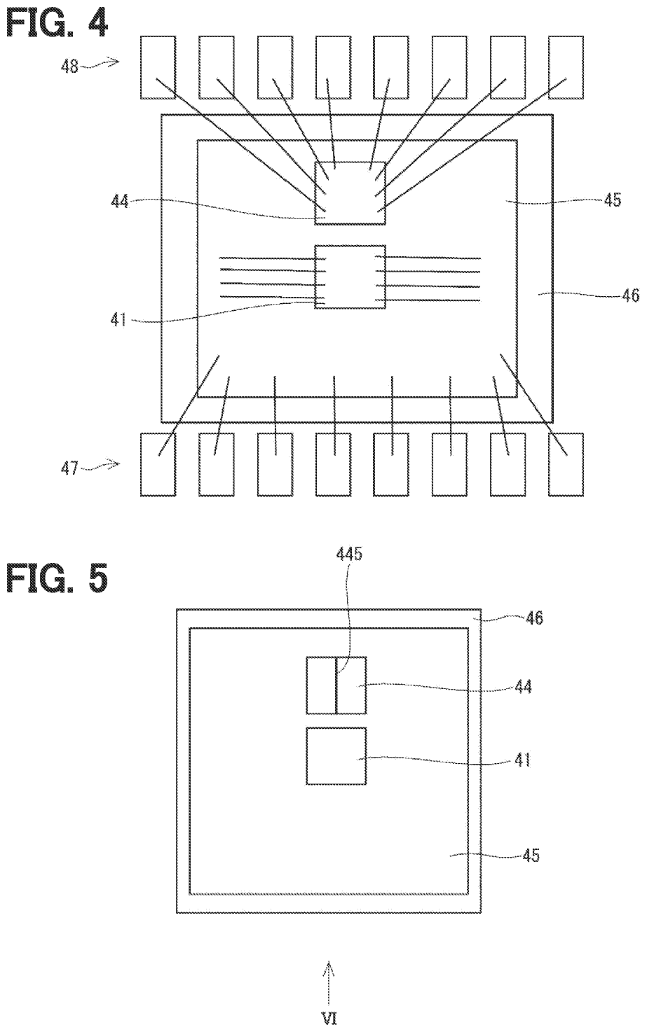

As shown in FIG. 4, the main chip 41 is connected to a terminal group 47 via a signal processing chip 45, and the sub chip 44 is directly connected to a terminal group 48 by wire bonding or the like. The terminal group 47 includes the output terminal 381, the power supply terminals 385 and 386, and the ground terminal. The terminal group 48 includes the output terminals 382 and 383, the power supply terminals 387 and 388, and the ground terminal.

As shown in FIGS. 4 to 6, the signal processing chip 45 is mounted on a lead frame 46, and the chips 41 and 44 are stacked on the surface of the signal processing chip 45 opposite to the lead frame 46. The chips 41 and 44 are fixed onto the signal processing chip 45 with a non-conductive adhesive 49. Hereinafter, a direction on the magnet 875 side when the tips are mounted on the board 21 is defined as an upper side.

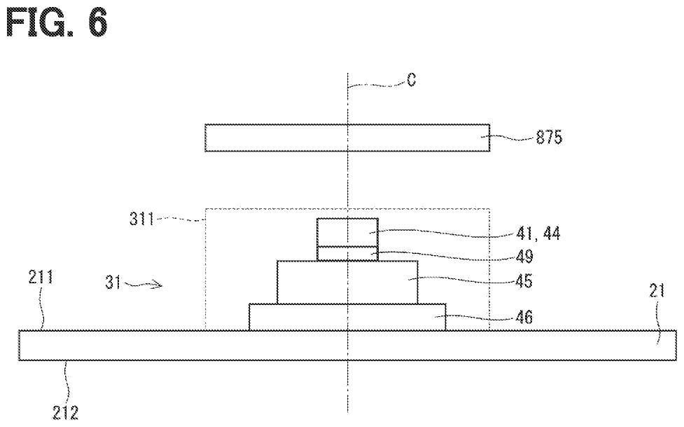

The main chip 41 is arranged approximately at the center of the signal processing chip 45, and the sub chip 44 is arranged apart from the main chip 41 to an extent that insulation can be ensured. FIG. 5 is a view schematically showing the arrangement of elements on the lead frame 46, and illustrations of the board 21, the terminal groups 47, 48, etc. are omitted. Further, FIG. 6 shows the internal configuration of the sealing part 311, and the size etc. do not necessarily match the actual size. The same applies to schematic views related to embodiments described later.

In the present embodiment, by forming the stacked structure in which the chips 41 and 44 are arranged on the signal processing chip 45, the size of the rotation angle sensor 31 can be reduced. Further, since the difference in physical distance between the detection elements 401 to 403 and the magnet 875 is small, detection errors can be reduced.

As described above, the rotation detection device 1 includes the rotation angle sensor 31 and the control unit 60. The rotation angle sensor 31 includes at least one main detection element 401 that detects a change in a physical quantity of a detection target, at least one (two in this embodiment) sub detection element 402, 403 that detect changes in the physical quantity of the same detection target as the main detection element, and the signal processing section 450 that processes the detection signal of the main detection element 401

The main detection element 401 and the sub detection elements 402 and 403 of the present embodiment detect the rotational state of the motor 80 which is the detection target, and detect a change in the magnetic field of the magnet 875 as the motor 80 rotates as a change in the physical quantity of the detection target. The control unit 60 acquires a signal corresponding to a change in the physical quantity of the detection target.

The rotation angle sensor 31 outputs to the control unit 60 a digital signal containing information generated by the signal processing section 450 that corresponds to the detection value of the main detection element 401 and an analog signal that corresponds to the detection value of the sub detection element 402.

The rotation angle sensor 31 of the present embodiment is a digital/analog mixed sensor that outputs a digital signal and an analog signal. In the present embodiment, the main detection element 401 is used for control, and the sub detection elements 402 and 403 are used for abnormality detection. Therefore, the signal processing section 450, which is a digital processing circuit, is provided for the main detection element 401, which requires detection accuracy, on the other hand, the digital processing circuit for the sub detection elements 402 and 403 for abnormality detection, which does not require detection accuracy compared to that for control, is omitted. Thereby, the configuration of the rotation angle sensor 31 can be simplified while ensuring the detection accuracy of the main detection element 401 for control.

The signal processing section 450 is configured as one signal processing chip 45 in which the AD conversion part 451 that digitally converts the detection value of the main detection element 401, the angle calculation part 452 that performs calculations using the digitally converted detection signal of the main detection element, the rotation number calculation part 453, and the communication part 455 that outputs digital signals to the control unit 60 are included. Thereby, the signal processing section 450 can be appropriately configured.

The main detection element 401, the sub detection element 402, and the signal processing section 450 are sealed with one sealing part 311. Further, the main chip 41 including the main detection element 401 and the sub chip 44 including the sub detection elements 402 and 403 are mounted on a signal processing chip 45 that constitutes the signal processing section 450. Thereby, the size of the rotation angle sensor 31 can be reduced. Furthermore, since the difference in physical distance between the magnet 875 and the detection elements 401 to 403 can be made relatively small, the detection errors between the sensors can be reduced.

In the rotation angle sensor 31, power supply terminals 385 to 388 used for supplying power to the main detection element 401 and the sub detection elements 402 and 403 are provided individually for each element. Thereby, even if an abnormality occurs in the power supply to some systems, detection in other systems can be continued.

The power supply terminals include a constant power supply terminal that is constantly supplied with power from the battery, and a terminal via power supply to which the power supply is cut off when the power is turned off. The constant power supply terminal is connected to the main chip 41 including the main detection element 401 and the signal processing section 450. In the present embodiment, the power supply terminal 385 corresponds to a “constant power supply terminal”, and the power supply terminals 386 to 388 correspond to “terminals via power supply”. Thereby, detection by the main detection element 401 and calculation by the signal processing section 450 can be continued while the IG power is turned off.

### Second Embodiment

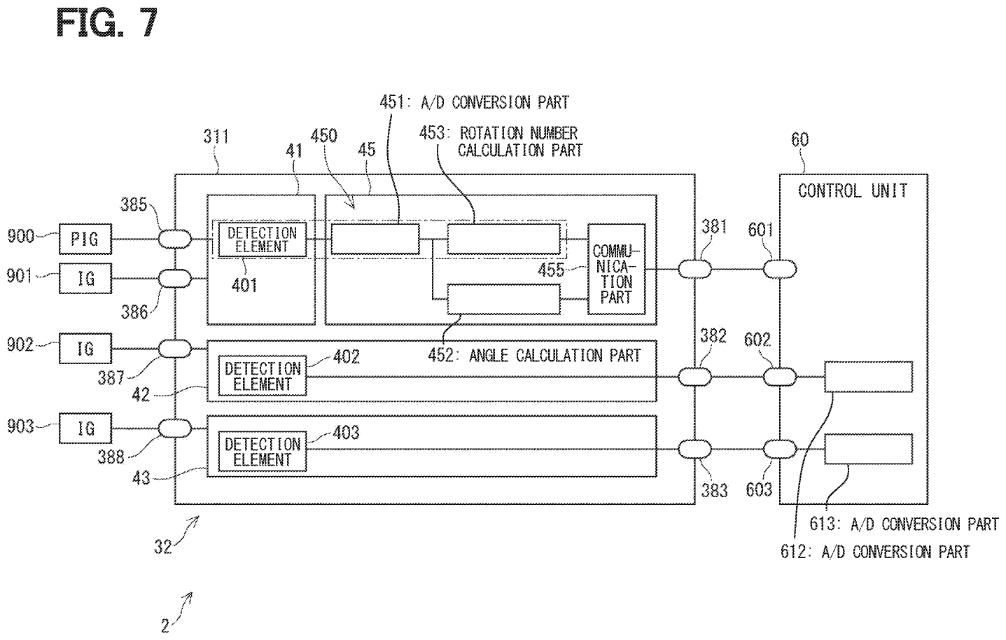

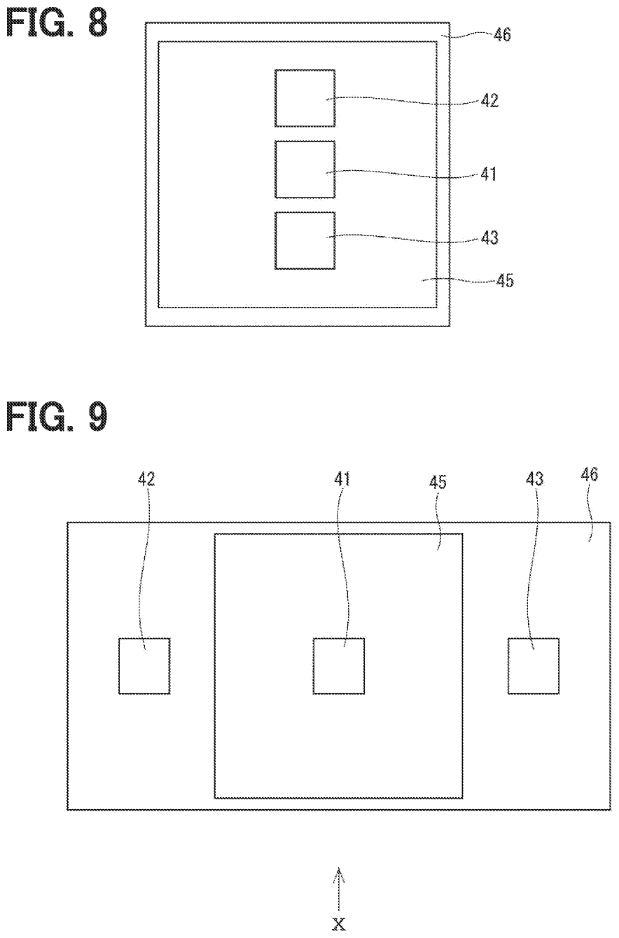

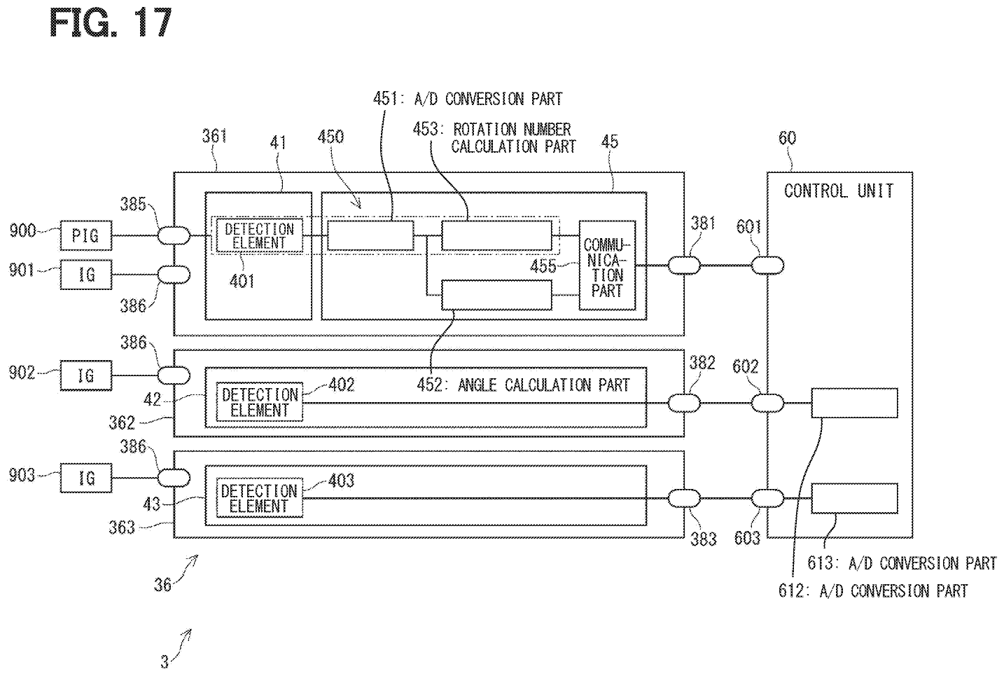

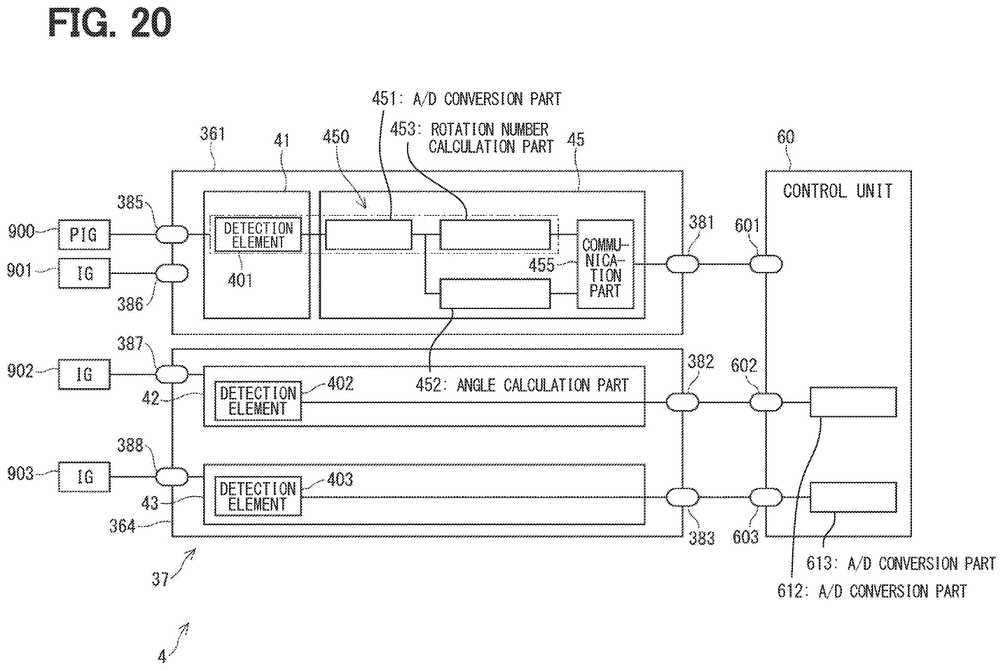

A second embodiment is shown in FIGS. 7 and 8. In FIG. 7, FIG. 17, and FIG. 20, description of the abnormality detection part 65 is omitted. Furthermore, the NC terminals 604 and 605 are omitted in the figures related to the subsequent embodiments. As shown in FIGS. 7 and 8, the rotation detection device 2 includes a rotation angle sensor 32 and the control unit 60. The rotation angle sensor 32 includes chips 41 to 43, a signal processing chip 45, and a sealing part 311 that seals these chips. A sub chip 42 has a sub detection element 402, and the sub chip 43 has a sub detection element 403. That is, in the present embodiment, the sub detection elements 402 and 403 are configured on separate chips.

As shown in FIG. 8, the chips 41 to 43 are mounted above the signal processing chip 45. The main chip 41 is arranged approximately at the center of the signal processing chip 45, and the sub chips 42 and 43 are arranged on both sides with the chip 41 in between. The same effects as those of the above embodiments can be obtained even in the configuration described above.

### Third Embodiment

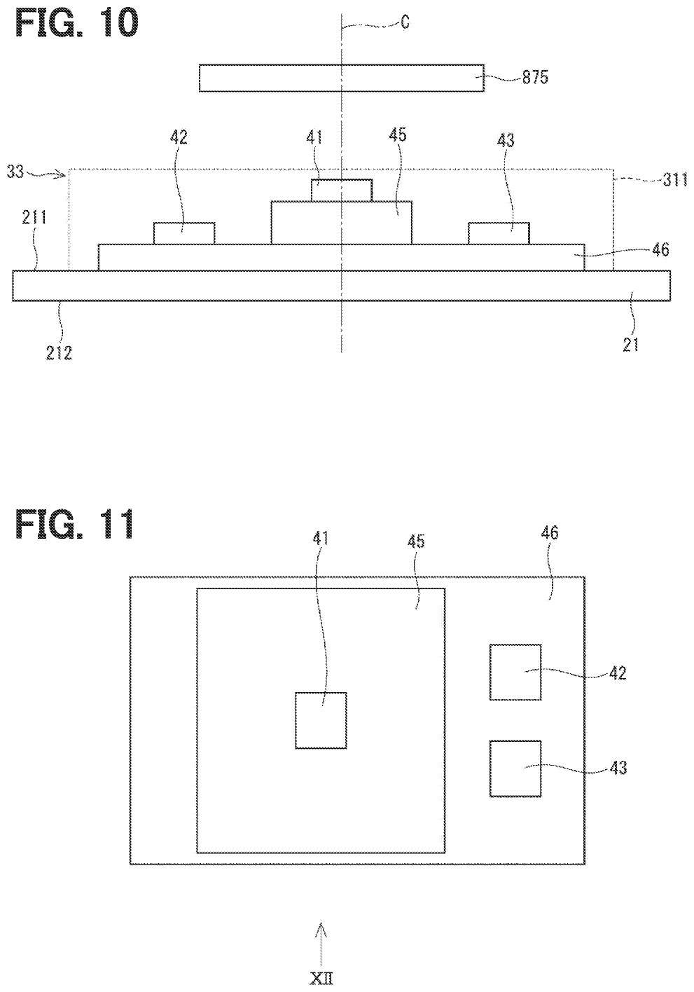

A third embodiment is shown in FIGS. 9 and 10. FIG. 10 is a side view corresponding to FIG. 6, but the description of the non-conductive adhesive 49 is omitted. The same is applicable to other embodiments described later. As shown in FIGS. 9 and 10, the rotation angle sensor 33 includes the chips 41 to 43, the signal processing chip 45, and the sealing part 311 that seals these chips, as in the second embodiment. The main chip 41 is mounted approximately at the center on the signal processing chip 45. The sub chips 42 and 43 are arranged on both sides of the signal processing chip 45 in between.

By arranging the main chip 41 on the center line C and arranging the sub chips 42 and 43 point-symmetrically with respect to the chip 41, an average of the outputs of the sub detection elements 402 and 403 can be made to substantially match the output of the main detection element 401. The point symmetrical arrangement means that an error to the extent that the average value of the detection values of the sub detection elements 402 and 403 can be considered to match the detection value of the main detection element 401 is allowed. Furthermore, the arrangement of sub chips 42, 43 maybe different from the arrangement in FIGS. 9 and 10. The same effects as those of the above embodiments can be obtained even in the configuration described above.

### Fourth and Fifth Embodiments

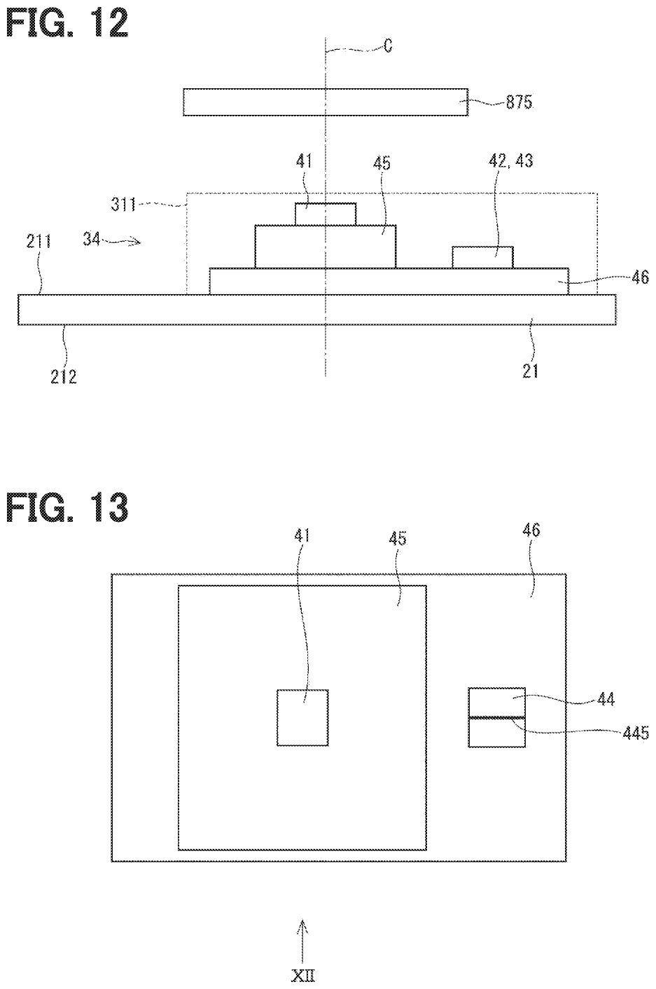

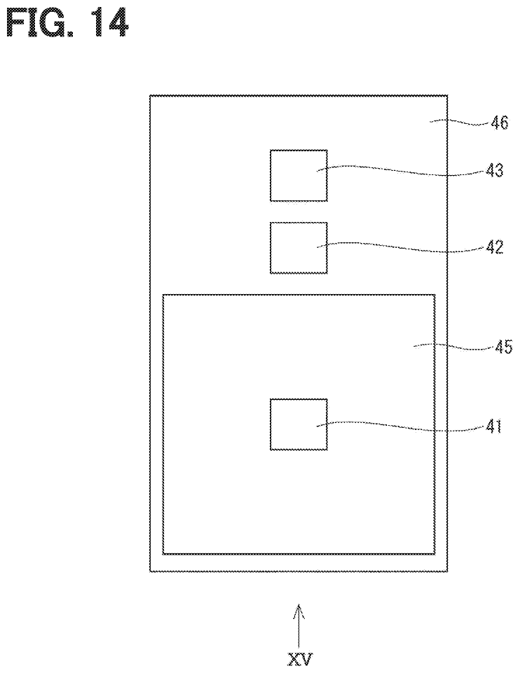

A fourth embodiment is shown in FIGS. 11 to 13, and a fifth embodiment is shown in FIGS. 14 to 16. As shown in FIGS. 11 and 12, in the rotation angle sensor 34 of the fourth embodiment, the main chip 41 is arranged on the signal processing chip 45, and the sub chips 42 and 43 are arranged along one side of the signal processing chip 45. By arranging the sub chips 42 and 43 adjacent to each other, the rotation angle sensor 34 can be downsized. Furthermore, detection errors of the sub detection elements 402 and 403 can be reduced.

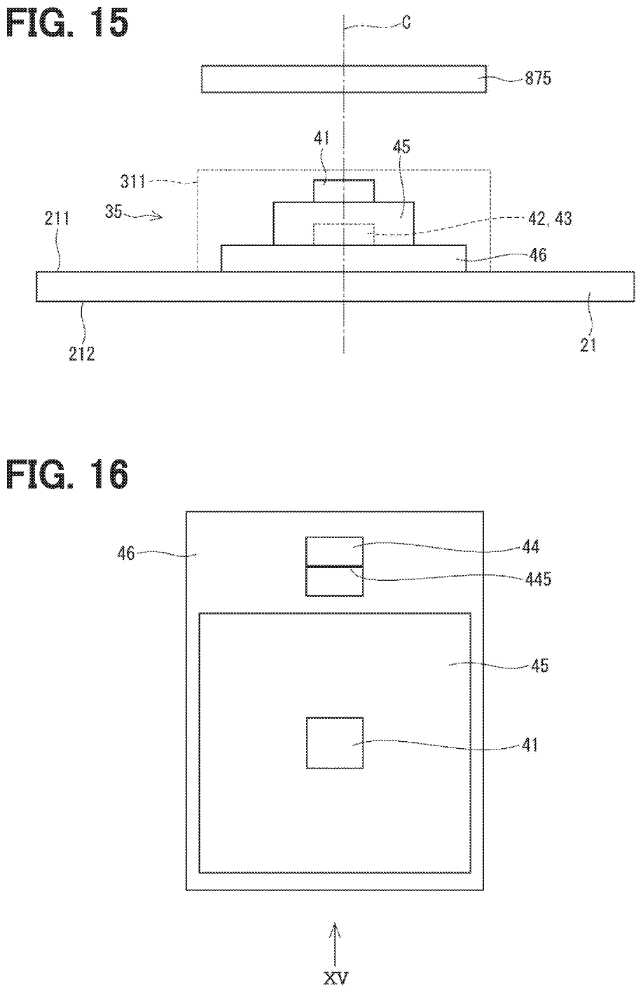

As shown in FIGS. 14 and 15, in the rotation angle sensor 35 of the fifth embodiment, the main chip 41 is arranged on the signal processing chip 45, and the sub chips 42 and 43 are arranged on one side of the signal processing chip 45 in the order of the sub chips 42 and 43 from the signal processing chip 45 side. Further, as in the first embodiment, the plurality of sub detection elements 402 and 403 may be configured in one sub chip 44 (see FIGS. 13 and 16). The same effects as those of the above embodiments can be obtained even in the configuration described above.

### Sixth Embodiment

A sixth embodiment is shown in FIGS. 17 to 19. As shown in FIG. 17, the rotation detection device 3 includes a rotation angle sensor 36 and the control unit 60. The rotation angle sensor 36 has three sealing parts 361, 362, and 363.

The main sealing part 361 is sealed with the main chip 41 and the signal processing chip 45, and is provided with an output terminal 381 and power supply terminals 385 and 386. The sub sealing part 362 is sealed with the chip 42, and is provided with an output terminal 382 and a power supply terminal 387. The sub sealing part 363 is sealed with the sub chip 43, and is provided with an output terminal 383 and a power supply terminal 388. That is, in the present embodiment, each detection element is packaged separately. By providing separate packages for each detection element, the degree of freedom in arrangement when mounting on the board 21 increases.

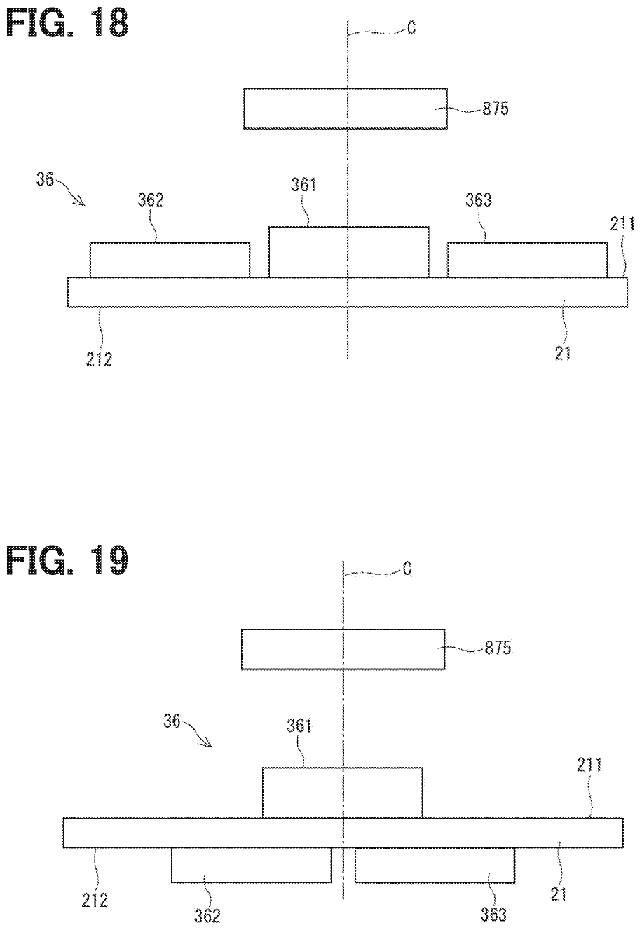

As shown in FIG. 18, the main sealing part 361 is arranged on the center line C on the motor surface 211 side of the board 21. The sub sealing parts 362 and 363 are arranged on both sides of the motor surface 211 of the board 21 with the main sealing part 361 in between. By arranging the sub sealing parts 362 and 363 point-symmetrically, an average of the outputs of the sub detection elements 402 and 403 can be made to substantially match the output of the main detection element 401.

Further, as shown in FIG. 19, the sub sealing parts 362 and 363 may be mounted on the cover surface 212 of the board 21. Thereby, the sub detection elements 402 and 403 can be brought close to the center line C, and the difference in distance between the magnet 875 and the detection elements 401 to 403 can be reduced, so that detection errors can be reduced.

In the rotation angle sensor 36 of the present embodiment, the main sealing part 361 including the main detection element 401 and the signal processing section 450 is provided separately from the sub sealing parts 362 and 363 including the sub detection elements 402 and 403. The degree of freedom in arrangement on the board 21 is increased.

Furthermore, by providing the sub sealing parts 362 and 363 on the back side of the main sealing part 361 with the board 21 in between, it is possible to reduce the difference in distance between the magnet 875 and the detection elements 401 to 403, thereby reducing detection errors. In addition, the same effects as that of the embodiment described above can be obtained.

### Seventh Embodiment

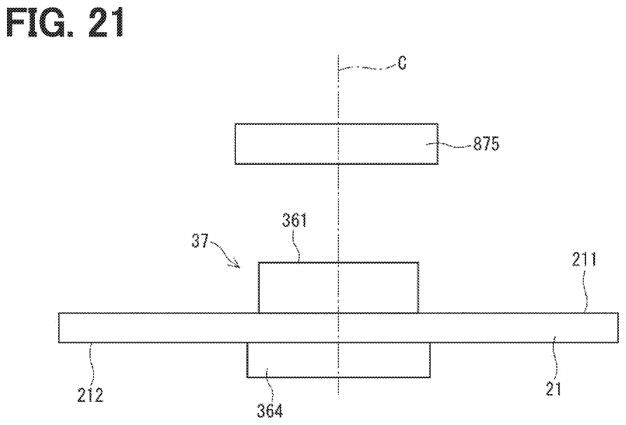

A seventh embodiment is shown in FIGS. 20 and 21. As shown in FIG. 20, the rotation detection device 4 includes a rotation angle sensor 37 and the control unit 60. The rotation angle sensor 37 has the sealing parts 361 and 364. The sub sealing part 364 is sealed with the sub chips 42, 43, and is provided with output terminals 382, 383 and power supply terminals 387, 388. That is, in the present embodiment, the sub detection elements 402 and 403 for abnormality detection are packaged in one package, and the main detection element 401 for control is packaged separately from the sub-detection elements 402 and 403 for abnormality detection. As shown in FIG. 21, the sealing part 364 is mounted on the center line C of the cover surface 212 of the board 21.

By packaging the sub detection elements 402 and 403 in one package, the mounting area on the board 21 can be reduced compared to the case where the sub detection elements 402 and 403 are individually packaged. Furthermore, since the distance between the magnet 875 and the sub detection elements 402 and 403 can be made relatively small, output errors between systems can be reduced. In addition, the same effects as those of the above embodiment can be obtained.

### Eighth Embodiment

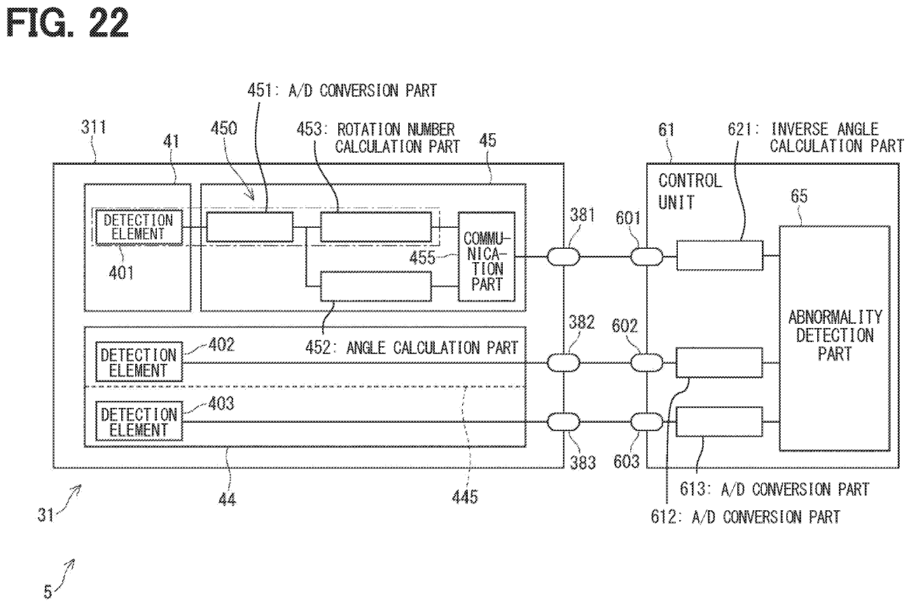

In an eighth embodiment and thereafter, the abnormality detection will be mainly described. The eighth embodiment is shown in FIG. 22. As shown in FIG. 22, the rotation detection device 5 includes a rotation angle sensor 31 and a control unit 61. In FIG. 22 and the like, the rotation angle sensor 31 of the first embodiment is shown as the configuration on the sensor side, but the rotation angle sensor 31 of the second embodiment or later may be used. Additionally, the description of the configuration related to the power supply is omitted.

The control unit 61 includes the AD conversion parts 612 and 613, an inverse angle calculation part 621, and the abnormality detection part 65. As described in the above embodiments, the detection value of the main detection element 401 is output to the control unit 61 as an angle-converted digital signal, and the detection value of the sub detection elements 402 and 403 is output to the control unit 61 as an analog signal. That is, since the data obtained by the control unit 61 is different between the detection value of the main detection element 401 and the detection values of the sub detection elements 402 and 403, a direct comparison cannot be made with data.

Therefore, in the present embodiment, the inverse angle calculation part 621 calculates a sine signal and a cosine signal based on the motor rotation angle θ included in the digital signal. Calculating a sine signal and a cosine signal from the motor rotation angle θ can be considered as converting the angle information into an analog output. The abnormality detection part 65 performs a comparison between the sine signals related to the detection elements 401 to 403 and a comparison between the cosine signals related to the detection elements 401 to 403. According to the above configuration, it is possible to detect an abnormality in the detection elements 401 to 403 and identify an abnormal system based on majority voting theory. In addition, the same effects as those of the above embodiment can be obtained.

### Ninth Embodiment

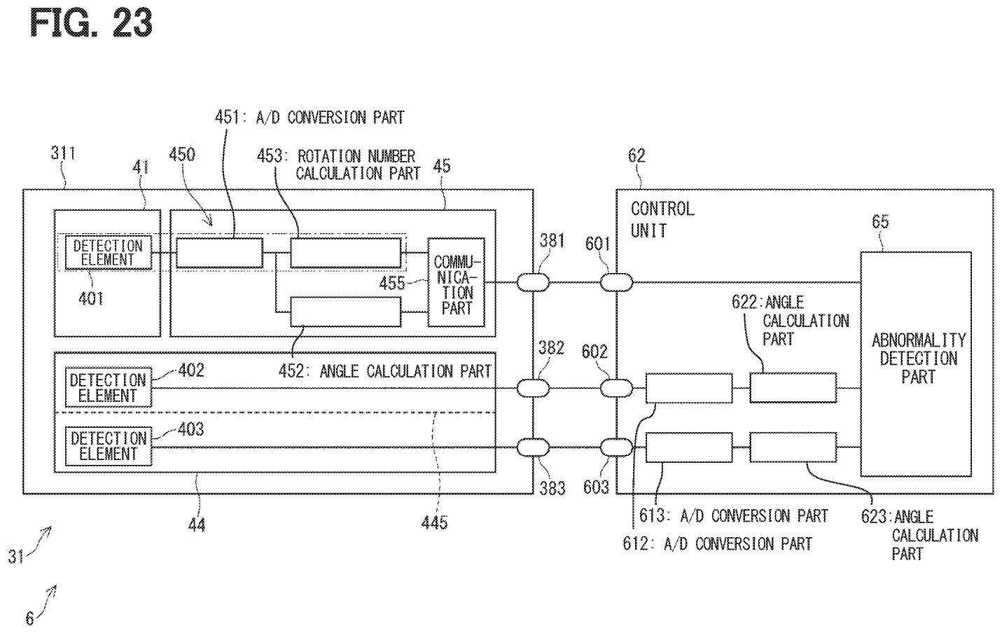

A ninth embodiment is shown in FIG. 23. As shown in FIG. 23, the rotation detection device 6 includes a rotation angle sensor 31 and a control unit 62. The control unit 62 includes the AD conversion parts 612 and 613, the angle calculation parts 622 and 623, and the abnormality detection part 65.

The angle calculation part 622 calculates the motor rotation angle θB using AD converted values of the sine signal and the cosine signal related to the sub detection element 402. The angle calculation part 623 calculates the motor rotation angle θC using the AD converted values of the sine signal and the cosine signal related to the sub detection element 403. Further, a motor rotation angle based on the detection value of the main detection element 401 calculated by the angle calculation part 452 is defined as θA.

The abnormality detection part 65 compares the motor rotation angles θA, θB, and θC calculated based on the detection values of the detection elements 401 to 403, therefore, it is possible to detect an abnormality in the detection elements 401 to 403 and identify an abnormal system based on majority voting theory. In addition, the same effects as those of the above embodiment can be obtained.

### Tenth Embodiment

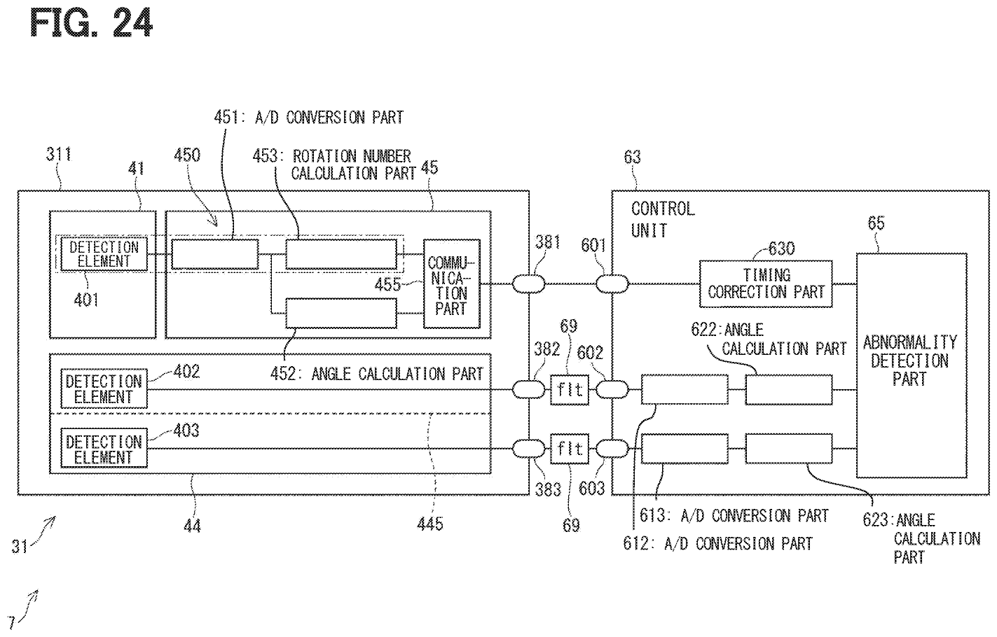

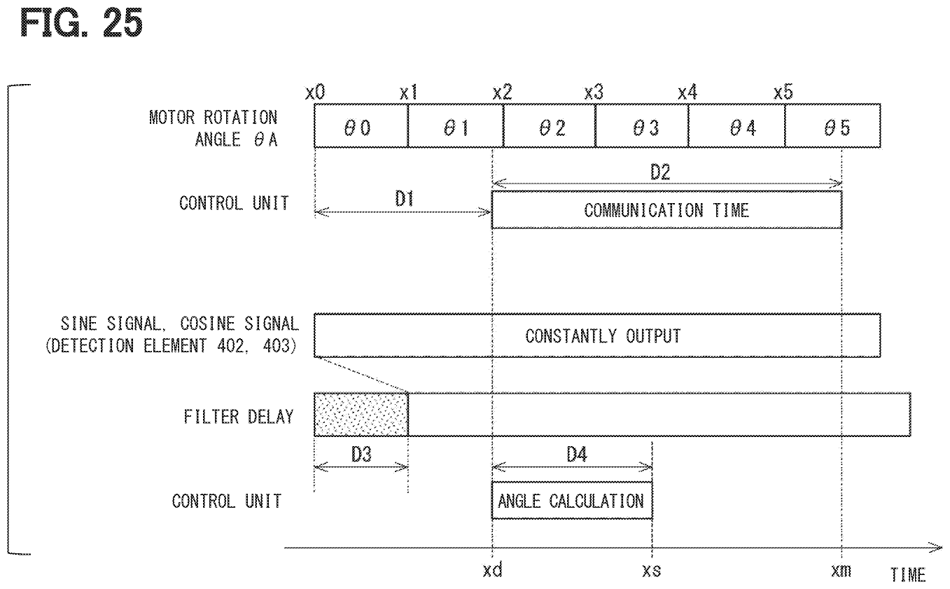

A tenth embodiment is shown in FIGS. 24 and 25. As shown in FIG. 24, the rotation detection device 7 includes a rotation angle sensor 31, a control unit 63, and a filter circuit 69. The filter circuit 69 suppresses noise in the sine and cosine signals of the detection elements 402 and 403.

The control unit 63 includes the AD conversion parts 612 and 613, the angle calculation parts 622 and 623, a timing correction part 630, an abnormality detection part 65, and the like. The timing correction part 630 performs a correction calculation to correct the difference between systems in the acquisition timing of the sine signal and the cosine signal used to calculate the motor rotation angles θA, θB, and θC used for abnormality detection.

The difference between systems in the acquisition timing of signals will be explained based on FIG. 25. As shown in FIG. 25, the motor rotation angle θA is periodically updated within the IC of the rotation angle sensor 31 in such a manner that the value θ0 calculated based on the detected value at time x0 is continued from time x0 to time x1, and the value θ1 calculated based on the detected value at time x1 is continued from time x1 to time x2 and the like. Here, for the sake of simplicity, the time required for AD conversion is omitted. FIG. 25 shows an angle θ0 corresponding to time x0 to an angle θ5 corresponding to time x5.

When the control unit 63 acquires data related to the main system from the rotation angle sensor 31 at time xd, the control unit 63 acquires data delayed by a delay time D1. The delay time D1 varies depending on a data update timing of the rotation angle sensor 31 and a data acquisition timing. Further, the motor rotation angle θA transmitted by the rotation angle sensor 31 at time xd becomes available for the abnormality detection at time xm after a delay time D2 corresponding to the communication time.

The analog signals output from the sub detection elements 402 and 403 are constantly input to the control unit 63. In the present embodiment, since the filter circuit 69 is provided, a delay time D3 occurs. Furthermore, when data is acquired at time xd, the motor rotation angles θB and θC can be used for the abnormality detection at time xs after a delay time D4 corresponding to the time required for angle calculation in angle calculation parts 622 and 623.

That is, the motor rotation angle θA obtained based on a command at time xd and the motor rotation angles θB and θC calculated based on the command at the same time xd differ according to the delay times D1 to D4. . In addition, since the motor rotation angles θA, θB, and θC are values that change over time according to the rotation of the motor 81, it is preferable that the abnormality detection part 65 performs the abnormality detection using values whose detection timings at the detection elements 401 to 403 are substantially simultaneous.

Therefore, in the present embodiment, the timing correction unit 630 performs estimation calculation to correct the difference of the data detection timing according to delay times D1 to D4, thereby reducing the difference of the detection timing of motor rotation angles θA, θB, and θC. The timing correction part 630 corrects the motor rotation angle θA by estimation based on a constant velocity straight line, estimation based on acceleration, etc., using the previous value, for example. Estimation may be performed using past values for multiple times. Further, in the present embodiment, the timing correction part 630 corrects the motor rotation angle θA, but it may also correct the motor rotation angles θB and θC, or may correct the motor rotation angles θA, θB, and θC, respectively. According to the above configuration, in particular, it is possible to suppress the angular deviation due to detection timing that occurs during a high speed rotation, and it is possible to appropriately detect abnormalities. In addition, the same effects as those of the above embodiment can be obtained.

### Eleventh Embodiment

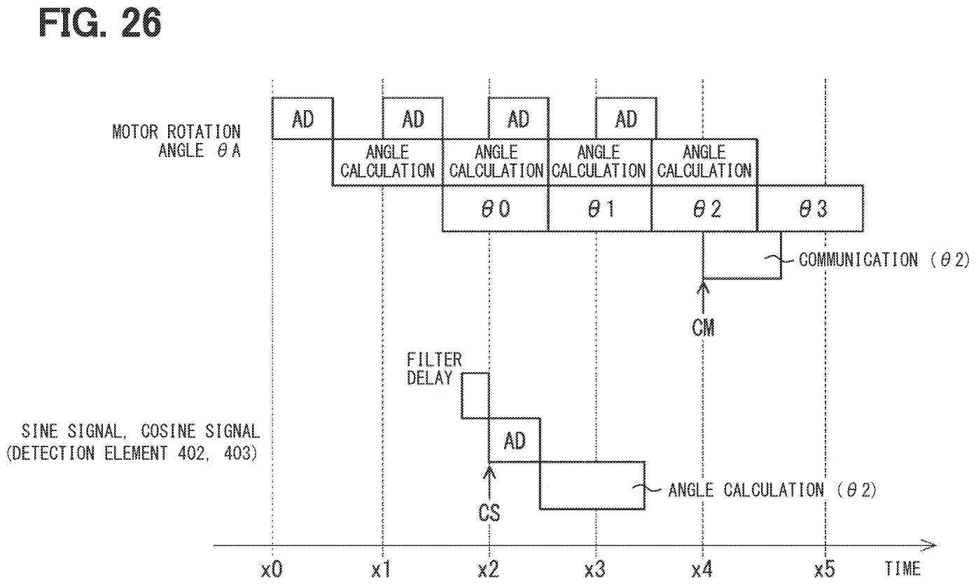

An eleventh embodiment is shown in FIG. 26. The configuration of the eleventh embodiment is the configuration shown in FIG. 23, so the explanation will focus on the acquisition timing of data used for the abnormality detection.

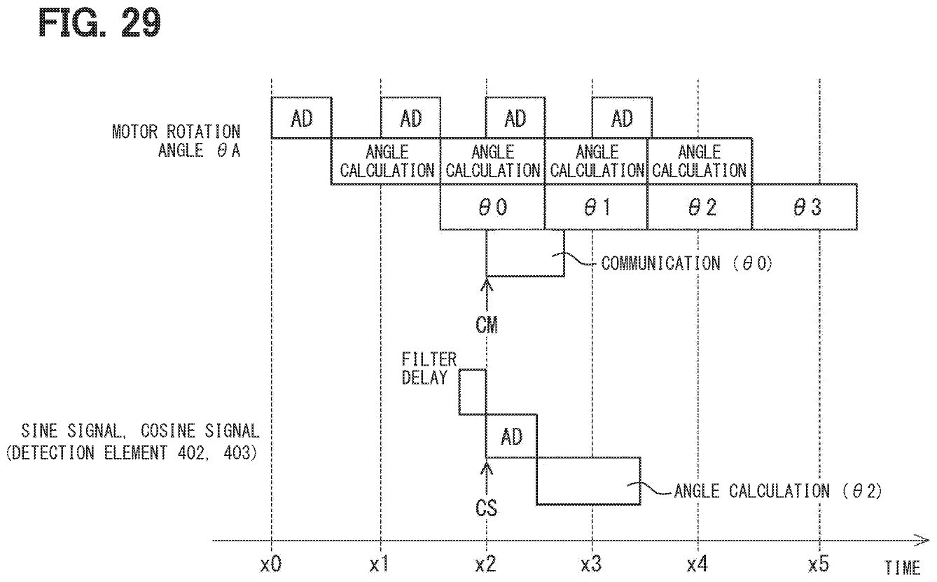

Prior to describing the eleventh embodiment, a reference example shown in FIG. 29 will be described. For the sake of simplicity, a description of the filter delay will be omitted here. As explained in the above embodiment, in the present embodiment, the detection value of the main detection element 401 is output to the control unit 62 by digital communication as the motor rotation angle θA calculated by the rotation angle sensor 31, and the detection values of the sub elements 402 and 403 are constantly outputted to the control unit 62 as analog signals.

As shown by an arrow CM in FIG. 29, when the motor rotation angle θA is obtained at time x2 in response to a command from the control unit 62, the obtained value becomes a value θ0 calculated based on the detection value at time x0. Further, as shown by an arrow CS, at time x2, which is the same timing as the arrow CM, when the AD conversion and the angle calculation of the sine and cosine signals related to the sub detection elements 402 and 403 are performed according to a command from the control unit 62, the calculated motor rotation angles θB and θC become the value θ2 calculated based on the detection value at time x2. Therefore, a data timing difference occurs between the motor rotation angle θA and the motor rotation angles θB and θC.

Therefore, in the present embodiment, the timing at which the control unit 62 instructs the main system to acquire the motor rotation angle θA and the timing at which it instructs the sub system to acquire data by AD conversion are made different. In the present embodiment, acquiring a digital signal from the communication part 455 is defined as data acquisition in the main system, and performing AD conversion in the AD conversion parts 612 and 613 is defined as data acquisition in the sub system.

As shown by an arrow CS in FIG. 26, at time x2, when the AD conversion and the angle calculation of the sine signal and the cosine signal related to the detection elements 402 and 403 are performed according to the command from the control unit 62, the calculated motor rotation angle θB and θC becomes the value θ2 calculated based on the detection value at time x2. The abnormality detection part 65 holds the values of the motor rotation angles θB and θC as the value θ2.

Further, as shown by an arrow CM, when the motor rotation angle θA is obtained by a command from the control unit 62 at time x4, which is a timing delayed from time x2 according to the AD conversion time and the angle calculation time, the obtained value becomes a value θ2 calculated based on the detection value at time x2. The abnormality detection part 65 compares the held motor rotation angles θB and θC with the motor rotation angle θA obtained with shifted timings, and the abnormality determination can be performed using data corresponding to detection values at approximately the same timing. The correction calculation in the tenth embodiment may be further performed. In addition, the same effects as that of the embodiment described above can be obtained.

### Twelfth Embodiment

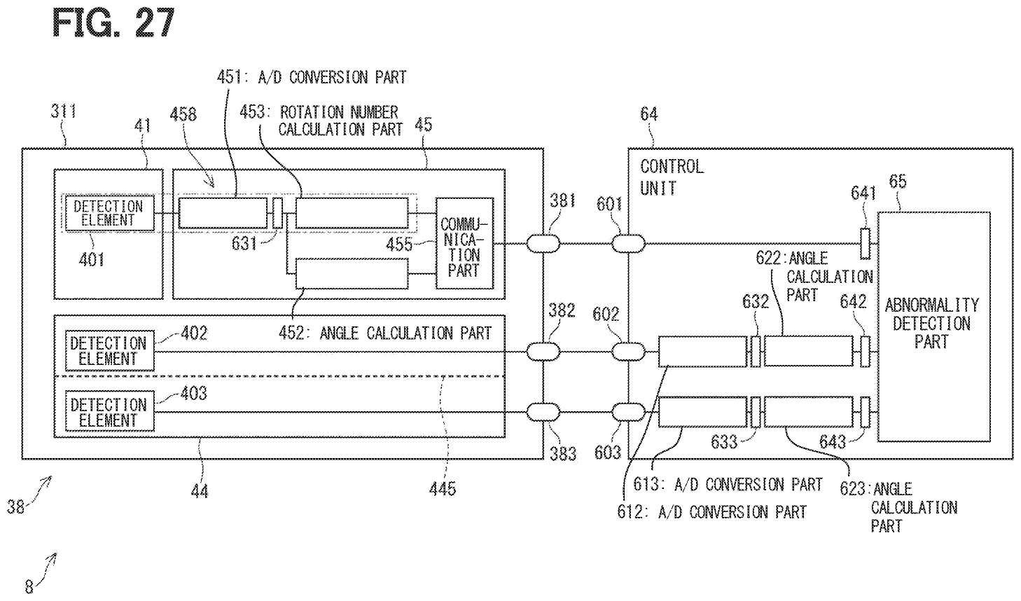

A twelfth embodiment is shown in FIG. 27. As shown in FIG. 27, the rotation detection device 8 includes a rotation angle sensor 38 and a control unit 64. A signal processing section 458 of the rotation angle sensor 38 is similar to the signal processing section 450 except that a signal correction part 631 is provided. Here, the chip configuration of the detection elements 401 to 403 is exemplified as that of the first embodiment, but it may also be that of the second embodiment or the like. The control unit 64 is similar to the control unit0 62 except that signal correction parts 632 and 633 and angle correction parts 641 to 643 are provided.

The signal correction parts 631 to 633 are respectively provided between the corresponding AD conversion parts 451, 612, 613 and the angle calculation parts 452, 622, 623. In the present embodiment, the signal correction part 631 related to the main system is provided in the rotation angle sensor 38, and the signal correction parts 632 and 633 related to the sub system are provided in the control unit 64. The signal correction parts 631 to 633 correct at least one of the amplitude, the phase, and the offset of the sine signal and the cosine signal output from the detection elements 401 to 403.

The angle correction parts 641 to 643 are located between the angle calculation parts 452, 622, and 623 and the abnormality detection part 65, and are provided in the control unit 64. The angle correction parts 641 to 643 correct the angular deviations caused by disturbances in the magnetic field due to disturbance magnetic fields, distance from the center of the magnet 875, assembly errors, etc., using map calculations, for example, regarding the calculated motor rotation angles θA, θB, and θC. Instead of map calculation, correction may be performed using a function such as a polynomial.

By providing the signal correction parts 631 to 633 and the angle correction parts 641 to 643, it is possible to prevent detection signal errors and angle calculation errors from being erroneously determined to be abnormal. Furthermore, by providing the signal correction parts 632, 633 and the angle correction parts 642, 643 in the sub system, the angle calculation can be continued with relatively high accuracy even during backup when an abnormality occurs in the main system.

Further, all of the signal correction parts 631 to 633 and the angle correction parts 641 to 643 do not necessarily need to be provided, and at least some of them may be omitted. For example, in the sub system, even if the signal correction and the angle correction are not performed, as long as the abnormality detection part 65 does not make a false judgment, by omitting the signal correction parts 632 and 633 or the angle correction parts 642 and 643, the configuration can be simplified. In addition, the same effects as those of the above embodiment can be obtained.

### Thirteenth Embodiment

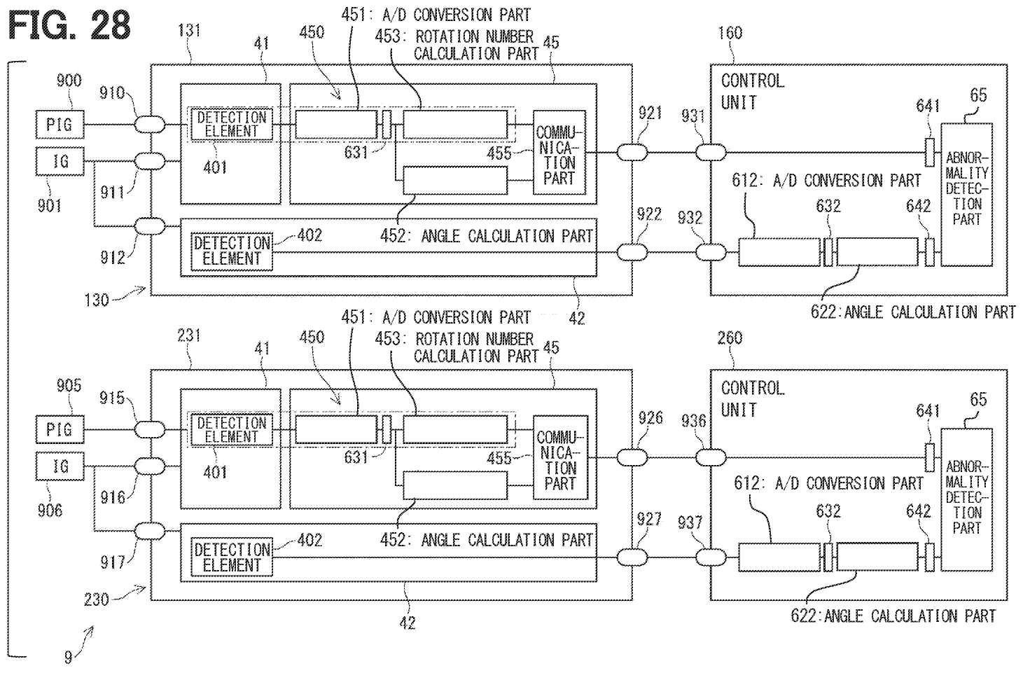

A thirteenth embodiment is shown in FIG. 28. As shown in FIG. 28, the rotation detection device 9 includes the rotation angle sensors 130, 230 and the control units 160, 260. The rotation angle sensors 130 and 230 are similar to those in the twelfth embodiment except that the system related to the detection element 403 is omitted and there is only one sub system. Furthermore, the control units 160 and 260 are similar to those in the twelfth embodiment, except that the system related to the detection element 403 is omitted and there is only one sub system. The rotation angle sensors 130, 230 may be configured to correspond to any of the embodiments described above. Further, the rotation angle sensor 130 and the rotation angle sensor 230 may have different configurations. The same applies to the control units 160 and 260.

The sealing part 131 of the rotation angle sensor 130 is provided with the power supply terminals 910 to 912. The power supply terminal 910 is connected to a PIG power supply 900, and the power supply terminals 911 and 912 are connected to an IG power supply 901. The sealing part 231 of the rotation angle sensor 230 is provided with the power supply terminals 915 to 917. The power supply terminal 915 is connected to the PIG power supply 905, and the power supply terminals 916 and 917 are connected to the IG power supply 906.

Further, the sealing part 131 is provided with the output terminals 921 and 922. The output terminal 921 is connected to the terminal 931 of the control unit 160 and is used to output a digital signal related to the main system. The output terminal 922 is connected to the terminal 931 of the control unit 160 and is used to output an analog signal related to the sub system.

The sealing part 231 is provided with the output terminals 926 and 927. The output terminal 926 is connected to the terminal 936 of the control unit 260 and is used to output a digital signal related to the main system. The output terminal 922 is connected to the terminal 927 of the control unit 260 and is used to output an analog signal related to the sub system.

In the present embodiment, since multiple sets (in the present embodiment, two sets) of combinations of the control units 160, 260 and the rotation angle sensors 130, 230 are provided, even if one of the control units becomes abnormal, the motor 80 can continue to be driven by the other control unit. In addition, the same effects as those of the above embodiment can be obtained.

In the above embodiments, the rotation detection devices 1 to 9 correspond to “detection device”, the motor 80 corresponds to “detection target”, the rotation angle sensors 31 to 38, 130, and 230 correspond to “sensor”, the angle calculation part 452 and the rotation number calculation part 453 correspond to “calculation part”, the power supply terminals 385, 910, and 915 correspond to “continuous power supply terminal”, and the power supply terminals 386 to 388, 911, 912, 916, and 917 correspond to “terminal via power supply”.

### Other Embodiments

In the embodiments described above, the rotation angle sensor is provided with one main detection element and one or two sub detection elements. In other embodiments, two or more main detection elements and three or more sub detection elements may be provided.

In the above embodiments, the power supply terminal is provided for each detection element. In other embodiments, the power supply terminal may be shared by a plurality of detection elements. Further, in the above embodiments, power is constantly supplied to the main chip. In other embodiments, it is not necessary to constantly supply power to the main chip.

In the above embodiments, one control unit is provided for one rotation angle sensor. In other embodiment, a plurality of control units may be provided for one rotation angle sensor. In the above embodiments, the sensor is a rotation angle sensor that detects the rotation of the motor. In other embodiments, the sensor may be other than a rotation angle sensor, such as a torque sensor or a steering sensor, and the detection target is not limited to a motor, but may be, for example, a steering shaft.

In the above embodiments, the motor is a three-phase brushless motor. In other embodiments, the motor unit is not limited to the three-phase brushless motor, and any motor may be used. Further, the motor may also be a generator, or may be a motor-generator having both of a motor function and a generator function, i.e., not necessarily be limited to the rotating electric machine. In the above embodiment, the detection device is applied to the electric power steering apparatus. As another embodiment, the detection device may be applied to any other devices different from the electric power steering device.

The control circuit and method described in the present disclosure may be implemented by a special purpose computer which is configured with a memory and a processor programmed to execute one or more particular functions embodied in computer programs of the memory. Alternatively, the control circuit described in the present disclosure and the method thereof may be realized by a dedicated computer configured as a processor with one or more dedicated hardware logic circuits. Alternatively, the control circuit and method described in the present disclosure may be realized by one or more dedicated computer, which is configured as a combination of a processor and a memory, which are programmed to perform one or more functions, and a processor which is configured with one or more hardware logic circuits. The computer programs may be stored, as instructions to be executed by a computer, in a tangible non-transitory computer-readable medium. The present disclosure is not limited to the embodiment described above but various modifications may be made within the scope of the present disclosure.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A detection device, comprising:
a sensor including at least one main detection element configured to detect a change in a physical quantity of a detection target, at least one sub detection element configured to detect a change in a physical quantity of the detection target, and a signal processing section configured to process a detection signal of the main detection element; and
a control unit configured to acquire a signal from the sensor according to a change in the physical quantity of the detection target;
wherein
the sensor outputs to the control unit a digital signal containing information generated by the signal processing section corresponding to a detection value of the main detection element and an analog signal corresponding to a detection value of the sub detection element.

2. The detection device according to claim 1, wherein
the signal processing section is configured as one signal processing chip in which an AD conversion part that digitally converts the detection value of the main detection element, an angle calculation part that performs calculations using the digitally converted detection signal of the main detection element, and a communication part that outputs digital signals to the control unit are included.

3. The detection device according to claim 1, wherein
the main detection element, the sub detection element, and the signal processing section are sealed with one sealing part.

4. The detection device according to claim 3, wherein
a main chip including the main detection element and a sub chip including the sub detection element are mounted on a signal processing chip constituting the signal processing section.

5. The detection device according to claim 1, wherein
a main sealing part including the main detection element and the signal processing section is provided separately from a sub sealing part including the sub detection element.

6. The detection device according to claim 5, wherein
the sub sealing part is provided on a back side of the main sealing part with a board in between.

7. The detection device according to claim 1, wherein
in the sensor, power supply terminals used for supplying power to the main detection element and the sub detection element are provided individually for each of the main detection element and the sub detection element.

8. The detection device according to claim 7, wherein
the power supply terminals include a constant power supply terminal that is constantly supplied with power from a battery, and a terminal via power supply to which the power supply is cut off when the power is turned off, and
the constant power supply terminal is connected to a main chip including the main detection element and the signal processing section.

9. The detection device according to claim 1, wherein
the main detection element and the sub detection element detect a rotational state of the detection target.
